(19) United States
(12) Patent Application Publication
(10) Pub. No.: US 2013/0138829 A1
(43) Pub. Date: May 30, 2013

(54) SCALABLE VIDEO CODING OVER REAL-TIME TRANSPORT PROTOCOL

(71) Applicant: Yuri Bulava, Tomsk City (RU)

(72) Inventor: Yuri Bulava, Tomsk City (RU)

(73) Assignee: Rovi Technologies Corporation, Santa Clara, CA (US)

(21) Appl. No.: 13/308,390

(22) Filed: Nov. 30, 2011

(51) Int. Cl. G06F 15/16

(52) U.S. Cl. 709/231

(57) ABSTRACT

Systems and methods for streaming video data via Real-time Transport Protocol (RTP) so that the bitrate of the streamed video adapts in response to measurements of network and decoder performance in accordance with embodiments of the invention are illustrated. In one embodiment of the invention, a system for streaming data includes a media server configured to stream video data having a first maximum bitrate utilizing RTP, a network client configured to connect to the media server wherein the network client is configured to measure network performance and video decoding performance and to send network and video decoder performance data to the network renderer utilizing the Real-time Transport Control Protocol (RTCP), wherein the network renderer is configured to stream video data having a second maximum bitrate in response to the network and video decoding performance data received from the network client.

### FIELD OF THE INVENTION

The present invention is directed, in general, to systems and methods for dynamically scaling digital video data based on network conditions and client performance; more specifically to scaling video data streamed utilizing the Real Time Protocol.

### BACKGROUND OF THE INVENTION

Streaming video over the Internet has become a phenomenon in modern times. Many popular websites, such as YouTube, a service of Google, Inc. of Mountain View, Calif., and WatchESPN, a service of ESPN of Bristol, Conn., utilize streaming video in order to provide video and television programming to those consumers who cannot or do not have access to a traditional television.

The Transmission Control Protocol (TCP) is a protocol for transmitting a stream of bytes over IP networks. TCP provides reliable, ordered delivery between endpoints on a network. TCP is designed to ensure accurate delivery, requiring that the receiving computer acknowledge each packet of data before delivering the data to the receiving computer. This acknowledgement process, while ensuring reliable, ordered delivery, can cause delays of up to several seconds if transmission errors occur.

A network control protocol to stream data over a network utilizing TCP is the Real. Time Messaging Protocol (RTMP), developed by Macromedia, which is now owned by Adobe, Inc. of San Jose, Calif. RTMP is the protocol used to stream Flash video between a Flash player and a server. RTMP is used in several websites, including YouTube. RTMP is Transmission Control. Protocol (TCP)-based, allowing for persistent connections and allowing low-latency communication. An RTMP client sends and receives data streams over the persistent connection.

The Real-time Transport Protocol (RTP) is a standardized packet format for delivering multimedia data over Internet Protocol (IP) networks. RTP commonly utilizes the User Datagram Protocol (UDP) as the transport layer; however, TCP may also be utilized for the transport layer. RTP is used in situations where stream data, such as audio or video data, must be transported end-to-end in real-time. RTP is optimized for speed of transmission rather than reliability; however RTP provides the ability to correct for common errors in data transferred over IP networks, such as jitter and data that has arrived out of sequence. RTP also contains a sub-protocol, the Real-time Transport Control Protocol (RTCP), which is used to specify quality of service feedback and synchronization between various RTP media streams. Several. RTCP message types are defined: sender report (SR), receiver report (RR), source description (SDES), end of participation (BYE), and application-specific message (APP). The definition and implementation of each type of message is described in Internet Engineering Task Force RFC 3550, the entirety of which is incorporated by reference.

One network control protocol to stream data over a network utilizing RTP is the Real. Time Streaming Protocol (RTSP), used by QuickTime Streaming Server, a product of Apple, Inc. of Cupertino, Calif., and Helix Universal. Server, a product of RealNetworks of Seattle, Wash. RTSP is used to establish and control media sessions between endpoints, such as between a media server and a client machine. The client machines can issue commands, such as play, pause, and stop, to enable the real-time control of playback of media files stored on the server.

Scalable Video Coding (SVC) is an extension of the H.264/MPEG-4 AVC video compression standard. SVC enables the encoding of a video bitstream that additionally contains one or more sub-bitstreams. The sub-bitstreams are derived from the video bitstream by dropping packets of data from the video bitstream, resulting in a sub-bitstream of lower quality and lower bandwidth than the original video bitstream. SVC supports three forms of scaling a video bitstream into sub-bitstreams: temporal scaling, spatial scaling, and quality scaling. Each of these scaling techniques can be used individually or combined depending on the specific video system.

### SUMMARY OF THE INVENTION

Systems and methods for dynamically scaling streaming video data based on network conditions and client performance in accordance with embodiments of the invention are disclosed. In one embodiment of the invention, a system for streaming data includes a media server configured to stream video data having a first maximum bitrate utilizing the Real-time Transport Protocol (RTP), a network client configured to connect to the media server wherein the network client is configured to measure network performance and video decoding performance and to send network and video decoder performance data to the network renderer utilizing the Real-time Transport Control Protocol (RTCP), wherein the network renderer is configured to stream video data having a second maximum bitrate in response to the network and video decoding performance data received from the network client.

In another embodiment of the invention, the video is encoded utilizing Scalable Video Coding (SVC).

In an additional embodiment of the invention, the network client is configured to send video decoder performance information utilizing a RTCP APP message.

In yet another additional embodiment of the invention, the network client is configured to send network performance information utilizing a RTCP RR message.

In still another embodiment of the invention, network renderer is configured to transmit video decoder configuration information to the network client utilizing RTCP.

Yet another embodiment of the invention includes a network client including a video decoder, where the video decoder is configured to decode video data, wherein the network client is configured to receive video data utilizing RTP, wherein the network client is configured to collect network and video decoder performance information, and wherein the network client is configured to send network and video decoder performance information using the network connection utilizing RTCP.

In still another embodiment of the invention, the video decoder is configured to decode SVC-encoded video data.

In yet still another embodiment of the invention, the network client is configured to send video decoder information utilizing a RTCP APP message.

In still another embodiment of the invention, the network client is configured to send network performance information utilizing a RTCP RR message.

In yet another additional embodiment of the invention, the network client is configured to receive video decoder information via RTCP and to update the video decoder configuration based upon the video decoder information.

Still another embodiment of the invention includes streaming video data, involving streaming video data having a first maximum bitrate from a network renderer to a network client utilizing RTP, receiving performance information regarding client performance and network performance utilizing RTCP, and streaming video data having a second maximum bitrate in response to the network and video decoding performance information received from the network client.

In another embodiment of the invention, the video data is encoded utilizing SVC.

In yet another embodiment of the invention, the video data having a second maximum bitrate is a sub-bitstream of the encoded SVC video data.

In still another embodiment of the invention, streaming video data further involves constructing a RTCP APP message containing performance information regarding client performance.

In yet another embodiment of the invention, streaming video data further involves constructing a RTCP RR message containing performance information regarding network performance.

In still yet another embodiment of the invention, streaming video data further involves sending an updated decoder configuration.

Yet another embodiment of the invention includes receiving streaming video data, involving receiving video data using a network client via RTP, decoding video data using a video decoder configured to decode video, analyzing video decoder performance, analyzing network performance, sending network and video decoder performance information to a network renderer via RTCP.

In yet another embodiment of the invention, analyzing decoding performance comprises analyzing frame type and time to decode one frame.

In still another embodiment of the invention, analyzing video decoder performance comprises constructing an RTCP APP message.

In another further embodiment of the invention, analyzing network performance comprises constructing an RTCP RR message.

Still yet another embodiment of the invention includes a machine readable medium containing processor instructions, where execution of the instructions by a processor causes the processor to perform a process involving receiving video data via a network connection, decoding video data, analyzing video decoder performance, analyzing network performance, and sending network and video decoder performance information to a network renderer via RTCP.

In a further embodiment of the invention, the process performed by a processor executing the instructions contained on the machine readable medium further comprises constructing a RTCP APP message containing video decoder performance information.

In yet another further embodiment of the invention, the process performed by a processor executing the instructions contained on the machine readable medium further comprises constructing a RTCP RR message containing network performance information.

### BRIEF DESCRIPTION OF THE DRAWINGS

FIG. 1 is a system diagram of a system for streaming video data in accordance with an embodiment of the invention.

FIG. 2 is a flow chart illustrating a process for streaming scaled video data in accordance with an embodiment of the invention.

FIG. 3 is a flow chart illustrating a process for determining and sending performance information in accordance with an embodiment of the invention.

FIG. 4 is a flow chart illustrating a process for dynamically scaling video data in accordance with an embodiment of the invention.

FIG. 5 conceptually illustrates a network client configured to perform dynamic video scaling in accordance with an embodiment of the invention.

### DETAILED DESCRIPTION

Turning now to the drawings, systems and methods for streaming video data via Real-time Transport Protocol (RTP) so that the bitrate of the streamed video adapts in response to measurements of network and decoder performance in accordance with embodiments of the invention are illustrated. In several embodiments of the invention, a network renderer is connected to a plurality of network clients and the network renderer is configured to provide streaming video data encoded using adaptive video formats to the network clients based upon measurements performed by the network clients concerning network and decoder performance. In a number of embodiments of the invention, the Scalable Video Codec (SVC) is used to encode and decode the adaptive video format. However, any streaming system in which a video renderer can adjust the bandwidth utilized in streaming video can be utilized in accordance with embodiments of the invention.

In many embodiments of the invention, the network client is configured to send measured performance information to the video renderer. In a number of embodiments of the invention, the network client is configured to send measured performance information to the video renderer utilizing RTCP. In several embodiments of the invention, the network renderer is configured to use performance information to scale the video quality and to provide an updated decoder profile to a network client. In several embodiments of the invention, decoder profiles are provided to the network client utilizing RTCP. By utilizing standard RTP and RTCP messages, backward compatibility with legacy systems is maintained while allowing for scalable video data to be harnessed. Systems and methods for streaming video data in accordance with embodiments of the invention are discussed further below.

### System Overview

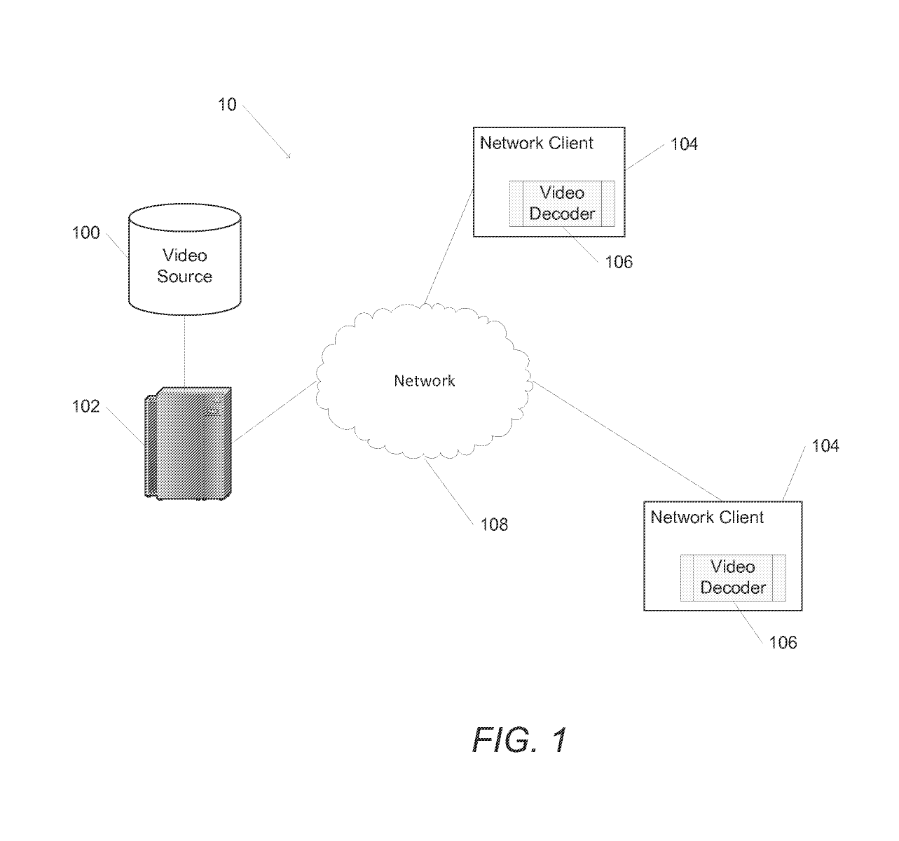

Video data networks in accordance with embodiments of the invention are configured to adapt the bitrate of the video transmitted to network clients based upon measurement of network and decoder performance. A video data network in accordance with an embodiment of the invention is illustrated in FIG. 1. The illustrated video data network 10 includes a video source 100. In a number of embodiments of the invention, the video source 100 contains pre-encoded video data. In several embodiments of the invention, the video source encodes video data in real time. In many embodiments of the invention, the video source contains video data encoded utilizing SVC. In a number of embodiments, the video source contains multiple streams with equal timelines as video data. The video source 100 is connected to a network renderer 102. In many embodiments of the invention, the network renderer 102 is implemented using a single machine. In several embodiments of the invention, the network renderer is implemented using a plurality of machines. In many embodiments of the invention, the network renderer and the video source are implemented using a media server. The network renderer 102 is connected to a plurality of network clients 104 utilizing a network 108. In many embodiments, the network 108 is the Internet. In several embodiments, the network 108 is any IP network. As discussed further below, the network renderer 102 is configured to send data to the network clients 104 utilizing RTP. In many embodiments of the invention, the network renderer 102 is configured to send data to the network clients utilizing RTCP.

The network clients 104 contain a video decoder 106. As is discussed further below, in many embodiments of the invention, the network client 104 is configured to measure the performance of the video decoder 106. In several embodiments of the invention, the video decoder 106 measures its own performance and sends performance data to the network client 104. In a number of embodiments of the invention, the network client 104 is configured to measure performance of the network connection with the network renderer 102. As is discussed further below, the network client 104 is configured to send performance data to the network renderer 102. In many embodiments of the invention, the performance data is sent utilizing RTCP.

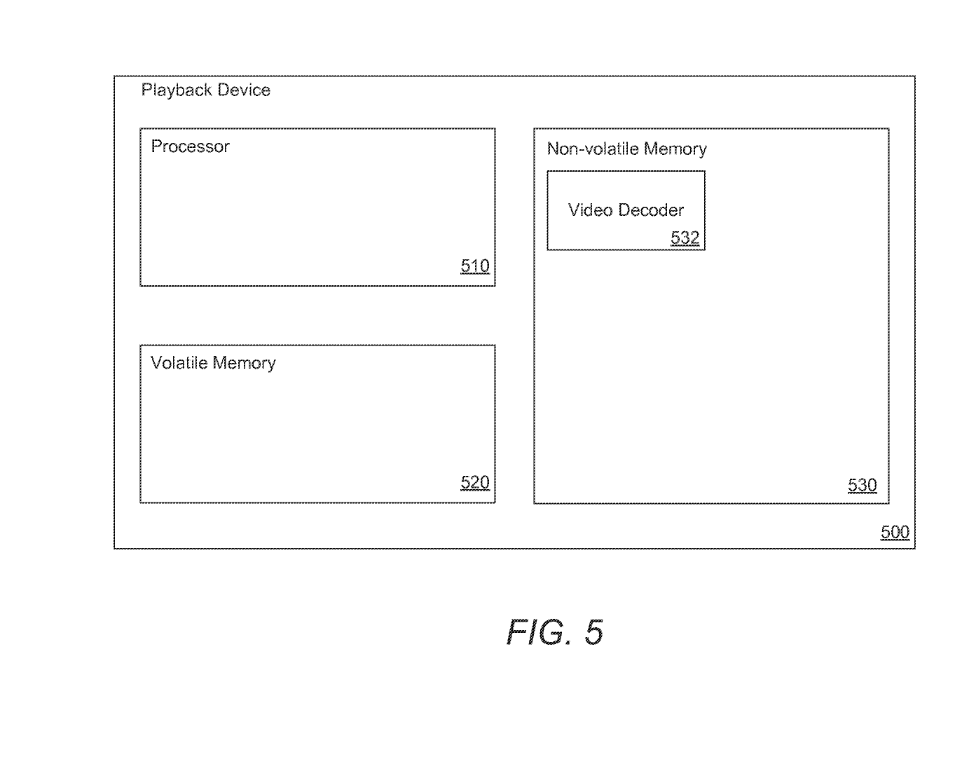

In many embodiments of the invention, network clients can include consumer electronics devices such as DVD players, Blu-ray players, televisions, set top boxes, video game consoles, tablets, and other devices that are capable of connecting to a server via RTP and playing back encoded media. The basic architecture of a network client in accordance with an embodiment of the invention is illustrated in FIG. 5. The network client 500 includes a processor 510 in communication with non-volatile memory 530 and volatile memory 520. In the illustrated embodiment, the non-volatile memory includes a video decoder 532 that configures the processor to decode scalable video data. Although a specific network client architecture is illustrated in FIG. 5, any of a variety of architectures including architectures where the video decoder is located on disk or some other form of storage and is loaded into volatile memory at runtime can be utilized to implement network clients for use in scalable video data streaming systems in accordance with embodiments of the invention.

Although a specific architecture of a video data network is shown in FIG. 1, other implementations appropriate to a specific application can be utilized in accordance with embodiments of the invention, including implementations that involve the transmission of data where the data has scalable quality levels. Processes for streaming video data in accordance with embodiments of the invention are discussed further below.

### Streaming Scalable Video

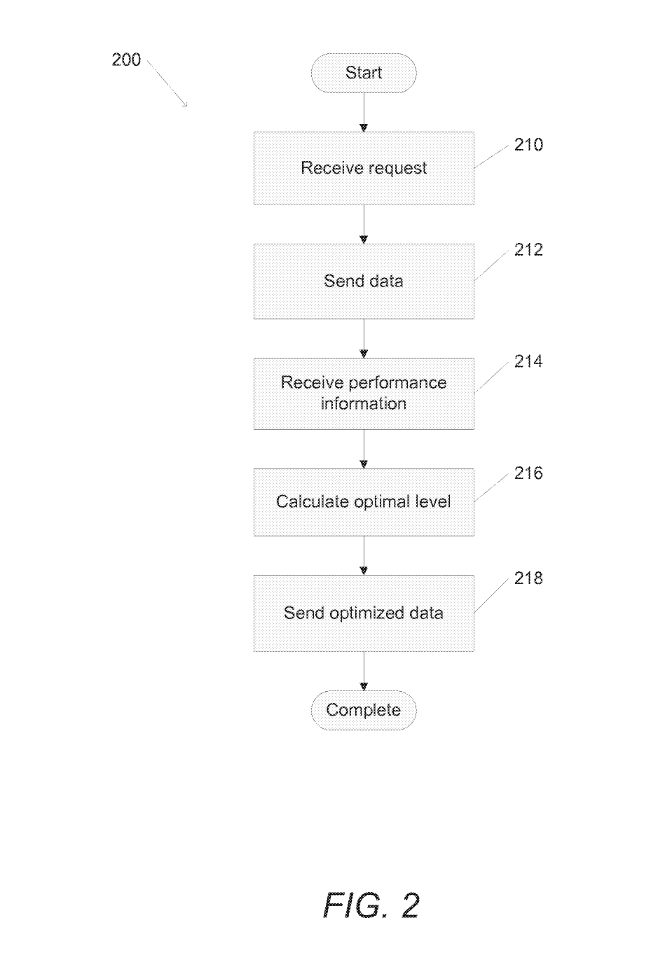

Processes for streaming video data in accordance with embodiments of the invention allow for modification of the video stream transmitted to a network client in response to measurements of network and video decoder performance. A process for streaming scalable video data in accordance with an embodiment of the invention is illustrated in FIG. 2. The process 200 for streaming scalable video data may begin with receiving (210) a request for video data. The process 200 includes sending (212) video data. In a number of embodiments of the invention, the data is sent utilizing RTP. Performance information including measurements of network performance and video decoder performance is received (214). In many embodiments of the invention, the performance of a video decoder is analyzed based on the frame type and the time for decoding at least one frame. In a number of embodiments of the invention, network quality information is analyzed. The network quality information may include, but is not limited to, information regarding jitter and drops. In several embodiments of the invention, performance information is received utilizing RTCP. Based upon factors including the received performance information, an appropriate video data level is determined (216) and video data at the appropriate level is sent (218) to the network client. In many embodiments, the video level determination (216) is performed by choosing a set of elementary streams of the video data with a combined maximum bitrate lower than the available network bandwidth. In a number of embodiments, the appropriate video data level determination (216) is related to the network client decoder performance, the performance of the network connection, and other factors including avoiding dropped frames.

In a number of embodiments of the invention, the video decoder performance received (214) is contained in an RTCP APP message having the following syntax: 2 bit protocol version, 1 bit padding, 5 bit APP packet sub-type, 8 bit packet type, 16 bit total length of packet, 32 bit SSRC, 32 bit unique name of APP packet, and a variable length application-dependent data. In several embodiments, the network performance is contained in a RTCP RR message as defined in IETF RFC 3550. In many embodiments of the invention, the process 200 repeats until an RTCP BYE message is received. In several embodiments of the invention, the process 200 repeats until there is no device available to receive the data. In a number of embodiments of the invention, the process 200 repeats until all data has been sent.

Although a specific process for streaming video data in response to measurements of network and decoder performance is shown in FIG. 2, other implementations appropriate to a specific application can be utilized in accordance with embodiments of the invention, including implementations that involve the transmission of any form of data with scalable quality levels. Processes for measuring and sending performance information in accordance with embodiments of the invention are discussed further below.

### Performance Information

In many embodiments of the invention, a network client generates performance information concerning both network performance and decoder performance and sends messages to a network renderer regarding the generated performance information. As discussed above with respect to FIG. 2, network renderers in accordance with many embodiments of the invention use the received (214) performance information to optimize data provided to the network client.

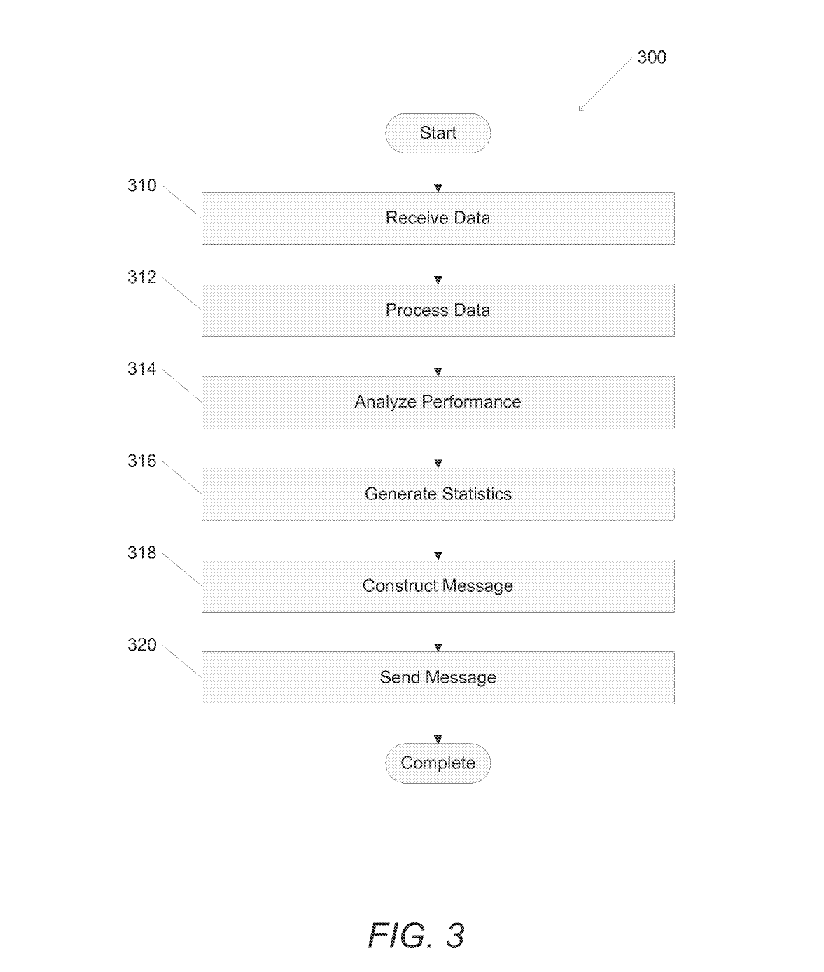

A process for determining and sending performance information in accordance with an embodiment of the invention is illustrated in FIG. 3. The process 300 involves receiving (310) video data. In many embodiments of the invention, the data is encoded using SVC. In a number of embodiments of the invention, the data is received utilizing RTP. The video data is processed (312). In several embodiments of the invention, a video decoder analyzes (314) network and decoder performance using processes similar to those outlined above. In many embodiments of the invention, a network client generates (316) performance statistics. A network client constructs (318) one or more messages that it uses to transmit performance information to a video renderer. In many embodiments, the network client generates a RTCP APP message containing performance information. In a number of embodiments, video decoder performance is stored in a RTCP APP message. In several embodiments, the RTCP APP message also contains network performance information. In other embodiments, the network client generates a separate RTCP RR message containing network performance information. A network client sends (320) one or more messages. In many embodiments of the invention, the messages are sent via RTCP.

Although a specific process for determining and sending performance information is shown in FIG. 3, other implementations appropriate to a specific application can be utilized in accordance with embodiments of the invention. Processes for dynamically scaling data in accordance with embodiments of the invention are discussed further below.

### Dynamically Scaling Video

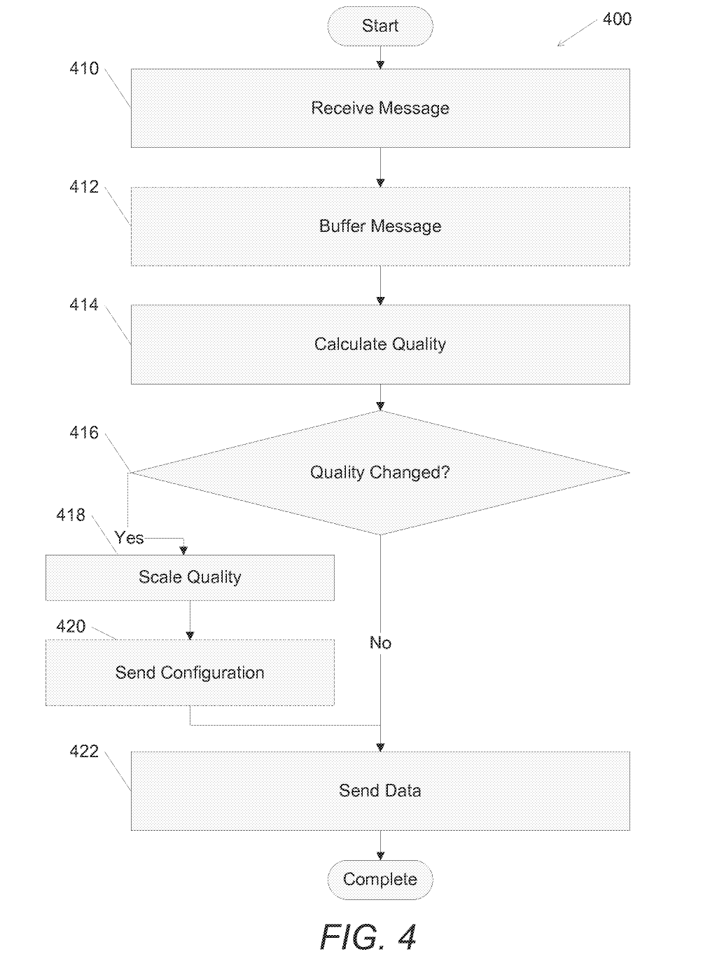

In several embodiments of the invention, a network renderer dynamically scales the data sent based on the performance of a network client. A process for dynamically scaling video data in accordance with an embodiment of the invention is illustrated in FIG. 4. The dynamic scaling process 400 involves receiving (410) messages containing performance information. In many embodiments of the invention, the messages include RTCP APP messages containing at least decoder performance information. In a number of embodiments of the invention, the messages also include RTCP RR messages containing network performance information. In several embodiments of the invention, a network renderer buffers (412) incoming messages and determines (414) the optimal scaled video data quality. The optimal scaled video data quality may be based on decoder performance and/or network performance. In several embodiments, one factor in determining decoder performance is analyzing the time it takes to process a frame of video. In many embodiments, network performance may be based on standard quality of service metrics, such as jitter and drops. In a number of embodiments of the invention, the optimal scaled video data quality is a sub-bitstream of video encoded using SVC. Although any of a variety of techniques for adapting the video streamed to the playback device can be utilized in accordance with embodiments of the invention.

A determination (416) is then made concerning whether the video quality has changed. If the scaled video data quality has not changed, scaled video data is sent (422). If the scaled video data quality level has changed, the video data quality is updated (418). For example, if the RTCP APP message contains information indicating that the video decoder is underutilized, the scaled video data quality level may be increased to better take advantage of the video decoder. Similarly, if the RTCP RR message contains information that drops are high, the scaled video data quality level may be decreased in order to improve performance. In many embodiments of the invention, the video data quality corresponds to a sub-bitstream of video data encoding using SVC. In a number of embodiments of the invention, a network renderer updates (418) the video data quality. In several embodiments of the invention, a video encoder updates the video data quality. In many embodiments of the invention, an updated decoder configuration may be necessary to decode the updated video data and an updated decoder configuration (420) is sent. The updated decoder configuration contains information required to decode the scaled video data, such as frame size, frame rate, the encoding used, and other relevant information. In several embodiments of the invention, the updated decoder configuration is a SVC decoder profile. In a number of embodiments of the invention, the updated decoder configuration is sent (420) utilizing RTCP. Scaled video data at the updated quality is then sent (422). In many embodiments of the invention, the updated decoder configuration is sent (422) with the scaled video data. In several embodiments of the invention, the data is sent utilizing RTP.

Although a specific process for dynamically scaling video data is shown in FIG. 4, other implementations appropriate to a specific application, including applications where alternative video encoding methods, such as adaptive bitrate streaming, are utilized, can be utilized in accordance with embodiments of the invention.

Although the present invention has been described in certain specific aspects, many additional modifications and variations would be apparent to those skilled in the art. It is therefore to be understood that the present invention may be practiced otherwise than specifically described without departing from the scope and spirit of the present invention. Thus, embodiments of the present invention should be considered in all respects as illustrative and not restrictive.

What is claimed:

1. A system for streaming data, comprising:
a media server configured to stream video data having a first maximum bitrate utilizing the Real-time Transport Protocol (RTP);
a network client configured to connect to the media server;
wherein the network client is configured to measure network performance and video decoding performance and to send network and video decoder performance data to the network renderer utilizing the Real-time Transport Control Protocol (RTCP);
wherein the network renderer is configured to stream video data having a second maximum bitrate in response to the network and video decoding performance data received from the network client.

2. The system of claim 1; wherein the video is encoded utilizing Scalable Video Coding (SVC).

3. The system of claim 1, wherein the network client is configured to send video decoder performance information utilizing a RTCP APP message.

4. The system of claim 1, wherein the network client is configured to send network performance information utilizing a RTCP RR message.

5. The system of claim 1, wherein the network renderer is configured to transmit video decoder configuration information to the network client utilizing RTCP.

6. A network client, comprising:
a video decoder, where the video decoder is configured to decode video data;
wherein the network client is configured to receive video data utilizing RTP;
wherein the network client is configured to collect network and video decoder performance information; and
wherein the network client is configured to send network and video decoder performance information using the network connection utilizing RTCP.

7. The network client of claim 6, wherein the video decoder is configured to decode SVC-encoded video data.

8. The network client of claim 6, wherein the network client is configured to send video decoder information utilizing a RTCP APP message.

9. The network client of claim 6, wherein the network client is configured to send network performance information utilizing a RTCP RR message.

10. The network client of claim 6, wherein the network client is configured to receive video decoder information via RTCP and to update the video decoder configuration based upon the video decoder information.

11. A method for streaming video data, comprising:
streaming video data having a first maximum bitrate from a network renderer to a network client utilizing RTP;
receiving performance information regarding client performance and network performance utilizing RTCP; and
streaming video data having a second maximum bitrate in response to the network and video decoding performance information received from the network client.

12. The method of claim 11, wherein the video data is encoded utilizing SVC.

13. The method of claim 12, wherein the video data having a second maximum bitrate is a sub-bitstream of the encoded SVC video data.

14. The network client of claim 11, further comprising constructing a RTCP APP message containing performance information regarding client performance.

15. The network client of claim 11, further comprising constructing a RTCP RR message containing performance information regarding network performance.

16. The method of claim 11, further comprising sending an updated decoder configuration.

17. A method for receiving streaming video data, comprising:
receiving video data using a network client via RTP;
decoding video data using a video decoder configured to decode video;
analyzing video decoder performance;
analyzing network performance; and
sending network and video decoder performance information to a network renderer via RTCP.

18. The method of claim 17, wherein analyzing decoding performance comprises analyzing frame type and time to decode one frame.

19. The method of claim 17, wherein analyzing video decoder performance comprises constructing an RTCP APP message.

20. The method of claim 17, wherein analyzing network performance comprises constructing an RTCP RR message.

21. A machine readable medium containing processor instructions, where execution of the instructions by a processor causes the processor to perform a process comprising:
receiving video data via a network connection;
decoding video data;
analyzing video decoder performance;
analyzing network performance; and
sending network and video decoder performance information to a network renderer via RTCP.

22. The machine readable medium of claim 21, wherein the process performed by a processor executing the instructions contained on the machine readable medium further comprises constructing a RTCP APP message containing video decoder performance information.

23. The machine readable medium of claim 21, wherein the process performed by a processor executing the instructions contained on the machine readable medium further comprises constructing a RTCP RR message containing network performance information.
